(19) United States
(12) Patent Application Publication
(10) Pub. No.: US 2016/0057756 A1
(43) Pub. Date: Feb. 25, 2016

(54) METHOD, NETWORK NODE, COMPUTER PROGRAM AND COMPUTER PROGRAM PRODUCT FOR COMBINED CELL

(71) Applicant: TELEFONAKTIEBOLAGET L M ERICSSON (PUBL), Stockholm (SE)

(72) Inventors: Sairamesh NAMMI, Kista (SE); Muhammad KAZMI, Bromma (SE)

(21) Appl. No.: 14/784,271

(22) PCT Filed: Apr. 14, 2014
(86) PCT No.: PCT/SE2014/050456

§ 371 Date: Oct. 13, 2015

Related U.S. Application Data
(60) Provisional application No. 61/812,357, filed on Apr. 16, 2013.

(51) Int. Cl. H04W 72/04

(52) U.S. Cl. CPC H04W 72/0466

(57) ABSTRACT

It is presented a method, performed in a network node of a combined cell of a mobile communication network, wherein the combined cell comprises a plurality of radio network nodes which all use the same cell identifier. The method comprises: determining that at least two wireless devices operate in the combined cell; and selecting orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell. Corresponding network nodes, computer program and computer program product are also presented.

### TECHNICAL FIELD

The invention relates to operation in a combined cell comprising a plurality of radio network nodes which all use the same cell identifier.

### BACKGROUND

During the last few years cellular operators have started to offer mobile broadband based on WCDMA (Wideband Code Division Multiple Access)/HSPA (High Speed Packet Access). Further, fuelled by new devices designed for data applications, the end user performance requirements are steadily increasing. The large uptake of mobile broadband has resulted in heavy traffic volumes that need to be handled by the HSPA networks. Therefore, techniques that allow cellular operators to manage their spectrum resources more efficiently are of large importance.

A few such techniques whereby it is possible to improve the downlink performance would be to introduce support for 4-branch MIMO (Multiple input multiple output), multiflow communication, multi carrier deployment, etc. Since improvements in spectral efficiency per link are approaching theoretical limits, the next generation technology is about improving the spectral efficiency per unit area. In other words, the additional features for HSDPA (High Speed Downlink Packet Access) need to provide a uniform user experience to users anywhere inside a cell by changing the topology of traditional networks. Currently 3GPP (3rd Generation Partnership Project) has been working on this aspect of using heterogeneous networks.

### SUMMARY

It is an object to enable better utilisation of downlink resources in combined cells.

According to a first aspect, it is presented a method, performed in a network node of a combined cell of a mobile communication network, wherein the combined cell comprises a plurality of radio network nodes which all use the same cell identifier. The method comprises: determining that at least two wireless devices operate in the combined cell; and selecting orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

The orthogonality of the CDMA channelization codes between the different radio network nodes allows simultaneous transmissions using the different network nodes. This significantly reduces interference between downlink transmissions to the at least two wireless devices.

The method may further comprise: determining that at least two of the at least two wireless devices are served by different radio network nodes.

The network node may be a high power node of the combined cell, such as a macro node. Performing the method in the high power node is an efficient implementation.

The selecting orthogonal CDMA channelization codes may comprise selecting a first set of at least one channelization code for downlink transmissions to a first set of wireless devices and selecting a second set of at least one channelization code for downlink transmissions to a second set of wireless devices, wherein the first set of at least one channelization code and the second set of at least one channelization code are orthogonal.

The selecting orthogonal CDMA channelization codes may comprise using a first mode, by selecting the first set of channelization codes for a high power node of the combined cell and the second set of channelization codes for all low power nodes of the combined cell. This is useful when there is no or only little overlap between the coverage areas of the low power nodes. Since there is only a limited number of channelization codes, it is economical to reuse the channelization codes for coverage areas for which mutual interference is low.

The selecting orthogonal CDMA channelization codes may comprise using a second mode, by selecting one set of CDMA channelization codes for each radio network node within the combined cell. In this way, the risk for interference between low power nodes is very low. This is particularly useful when there is considerable overlap in coverage areas for different radio network nodes.

The selecting orthogonal CDMA channelization codes may comprise using a third mode, by selecting a set of at least one spatially reused CDMA channelization code for all radio network nodes within the combined cell for use in downlink transmissions, and at least two sets of orthogonal CDMA channelization codes according for use in the first mode or the second mode.

The method may further comprise: determining a mode to use based on any one or more of the following criteria: user traffic or service characteristics, load, signal quality, wireless device capability of handling different modes, user traffic characteristics and wireless device receiver capability.

The codes of each selected set of CDMA channelization codes may be orthogonal to each code of any other selected set of CDMA channelization codes.

The selecting orthogonal CDMA channelization codes may comprise reusing the same CDMA channelization codes for low power nodes arranged such that there is only minimal risk of them interfering with each other.

The method may further comprise: configuring radio network nodes in accordance with the mode used.

The configuring may comprise assigning selected CDMA channelization codes.

In the selecting orthogonal CDMA channelization codes, the downlink transmission may relate to transmissions over a physical downlink shared channel.

The method may further comprise: receiving a capability of the wireless device indicating its capability of handling of spatially reused CDMA channelization codes, orthogonally assigned channelization codes, or both.

According to a second aspect, it is presented a network node arranged to be part of a combined cell of a mobile communication network, wherein the combined cell comprises a plurality of radio network nodes which all use the same cell identifier. The network node comprises: a processor; and a computer program product storing instructions that, when executed by the processor, causes the network node to: determine that at least two wireless devices operate in the combined cell; and select orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

The network may further comprise instructions that, when executed by the processor, causes the network node to determine that at least two of the at least two wireless devices are served by different radio network nodes.

The network node may be arranged to be a high power node of the combined cell.

The high power node may be a macro node.

The instructions to select orthogonal CDMA channelization codes may comprise instructions that, when executed by the processor, causes the network node to select a first set of at least one channelization code for downlink transmissions to a first set of wireless devices and selecting a second set of at least one channelization code for downlink transmissions to a second set of wireless devices, wherein the first set of at least one channelization code and the second set of at least one channelization code are orthogonal.

The instructions to select orthogonal CDMA channelization codes may comprise instructions that, when executed by the processor, causes the network node to use a first mode, by selecting the first set of channelization codes for a high power node of the combined cell and the second set of channelization codes for all low power nodes of the combined cell.

The instructions to select orthogonal CDMA channelization codes may comprise instructions that, when executed by the processor, causes the network node to use a second mode, by selecting one set of CDMA channelization codes for each radio network node within the combined cell.

The instructions to select orthogonal CDMA channelization codes may comprise instructions that, when executed by the processor, causes the network node to use a third mode, by selecting a set of at least one spatially reused CDMA channelization code for all radio network nodes within the combined cell for use in downlink transmissions, and at least two sets of orthogonal CDMA channelization codes according for use in the first mode or the second mode.

The network node may further comprise instructions that, when executed by the processor, causes the network node to determine a mode to use based on any one or more of the following criteria: user traffic or service characteristics, load, signal quality, wireless device capability of handling different modes, user traffic characteristics and wireless device receiver capability.

The codes of each selected set of CDMA channelization codes may be orthogonal to each code of any other selected set of CDMA channelization codes.

The instructions to select orthogonal CDMA channelization code may comprise instructions that, when executed by the processor, causes the network node to reuse the same CDMA channelization codes for low power nodes arranged such that there is only minimal risk of them interfering with each other.

The network may further comprise instructions that, when executed by the processor, causes the network node to configure radio network nodes in accordance with the mode used.

The instructions to configure may comprise instructions that, when executed by the processor, causes the network node to assign selected CDMA channelization codes.

The downlink transmission may relate to transmissions over a physical downlink shared channel.

The network node may further comprise instructions that, when executed by the processor, causes the network node to receive a capability of the wireless device indicating its capability of handling of spatially reused CDMA channelization codes, orthogonally assigned channelization codes, or both.

According to a third aspect, it is presented a network node comprising: means for determining that at least two wireless devices operate in a combined cell comprising the network node, wherein the combined cell forms part of a mobile communication network and comprises a plurality of radio network nodes which all use the same cell identifier; and means for selecting orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

The network node may further comprise means for determining that at least two of the at least two wireless devices are served by different radio network nodes.

The network node may be a high power node of the combined cell.

The high power node may be a macro node.

The means for selecting orthogonal CDMA channelization codes may comprise means for selecting a first set of at least one channelization code for downlink transmissions to a first set of wireless devices and means for selecting a second set of at least one channelization code for downlink transmissions to a second set of wireless devices, wherein the first set of at least one channelization code and the second set of at least one channelization code are orthogonal.

The means for selecting orthogonal CDMA channelization codes may comprise means for using a first mode, by selecting the first set of channelization codes for a high power node of the combined cell and the second set of channelization codes for all low power nodes of the combined cell.

The means for selecting orthogonal CDMA channelization codes may comprise means for using a second mode, by selecting one set of CDMA channelization codes for each radio network node within the combined cell.

The means for selecting orthogonal CDMA channelization codes may comprise means for using a third mode, by selecting a set of at least one spatially reused CDMA channelization code for all radio network nodes within the combined cell for use in downlink transmissions, and at least two sets of orthogonal CDMA channelization codes according for use in the first mode or the second mode.

The network node may further comprise means for determining a mode to use based on any one or more of the following criteria: user traffic or service characteristics, load, signal quality, wireless device capability of handling different modes, user traffic characteristics and wireless device receiver capability.

The codes of each selected set of CDMA channelization codes may be orthogonal to each code of any other selected set of CDMA channelization codes.

The means for selecting orthogonal CDMA channelization codes may comprise means for reusing the same CDMA channelization codes for low power nodes arranged such that there is only minimal risk of them interfering with each other.

The network node may further comprise means for configuring radio network nodes in accordance with the mode used.

The means for configuring may comprise means for assigning selected CDMA channelization codes.

The means for selecting orthogonal CDMA channelization codes may comprise means for considering the downlink transmission to relate to transmissions over a physical downlink shared channel.

The network node may further comprise means for receiving a capability of the wireless device indicating its capability of handling of spatially reused CDMA channelization codes, orthogonally assigned channelization codes, or both.

According to a fourth aspect, it is presented a computer program comprising computer program code which, when run on a network node of a combined cell of a mobile communication network, the combined cell comprising a plurality of radio network nodes which all use the same cell identifier, causes the network node to: determine that at least two wireless devices operate in the combined cell; and select orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

According to a fifth aspect, it is presented a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating one deployment of low power nodes in a heterogeneous network;

FIG. 2 is a schematic diagram illustrating how low power nodes have different cell ids;

FIG. 3 is a schematic diagram illustrating low power nodes being part of a macro cell, also called soft cell;

FIG. 4 is a pictorial view of SFN (Single Frequency Network) in a combined cell deployment;

FIG. 5 is a pictorial view of spatial reuse in a combined cell deployment;

FIG. 6 is a schematic diagram illustrating one deployment scenario of a combined cell;

FIG. 7 is a schematic diagram illustrating a combined cell deployment when the UE is in the vicinity of strong interference;

FIG. 8 is a schematic graph illustrating link performance with low interference;

FIG. 9 is a schematic graph illustrating link performance with strong interference;

FIG. 10 is a schematic diagram illustrating some components of a UE;

FIG. 11 is a schematic diagram illustrating some components of a radio network node;

FIG. 12 is a schematic diagram illustrating some components of a network node exemplified as a central controller;

FIG. 13 is a schematic diagram illustrating an environment in which embodiments presented herein can be applied;

FIGS. 14A-B are flow charts illustrating embodiments of methods performed in the network node of FIGS. 1-3; and

FIG. 15 is a schematic diagram showing functional modules of the software instructions of the network node of FIGS. 1-3 according to one embodiment; and

FIG. 16 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

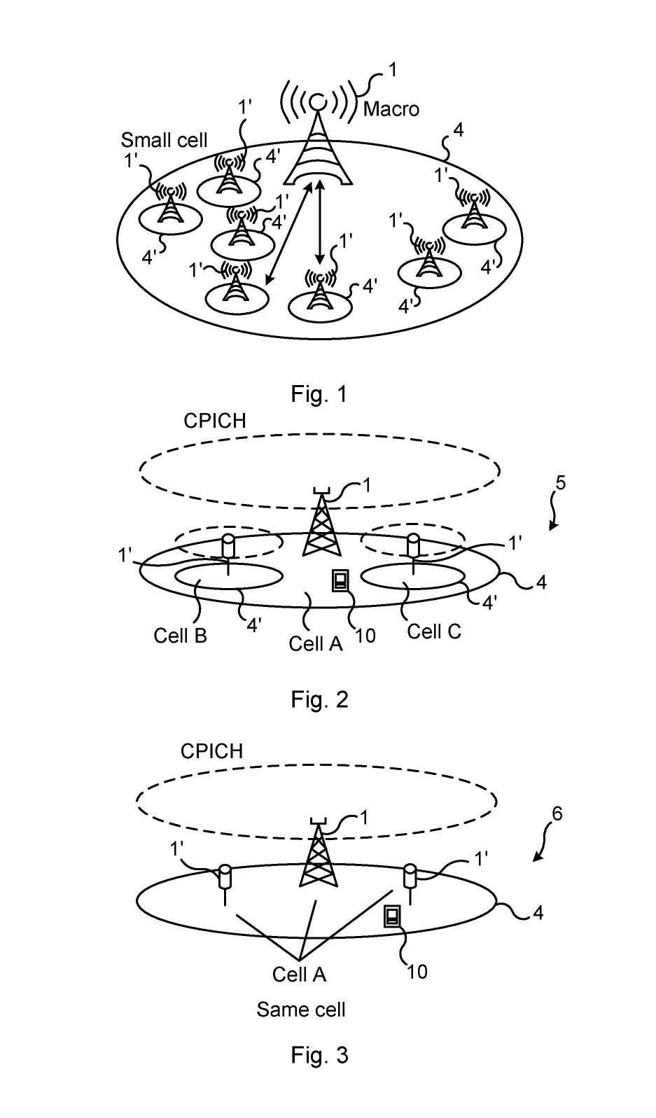

FIG. 1 is a schematic diagram illustrating one deployment of low power nodes in a heterogeneous network.

The different terminologies related to nodes in the network used herein are elaborated below:

Radio Network Node:

In some embodiments the non-limiting term radio network node is more commonly used and it refers to any type of network node serving UE (User Equipment) and/or connected to other network node or network element or any radio node from where UE receives signal. Examples of radio network nodes are Node B, base station (BS), multi-standard radio (MSR) radio node such as MSR BS (Multi-Standard Radio Base Station), eNode B (evolved Node B), network controller, radio network controller (RNC), base station controller, relay, donor node controlling relay, base transceiver station (BTS), access point (AP), transmission points, transmission nodes, RRU (Remote Radio Unit), RRH (Remote Radio Head), nodes in distributed antenna system (DAS) etc.

Network Node:

In some embodiments a more general term “network node” is used and it can correspond to any type of radio network node or any network node, which communicates with at least a radio network node. Examples of network node are any radio network node stated above, central controller (20 of FIG. 6) core network node (e.g. MSC (Mobile Switching Centre), MME (Mobility Management Entity), etc.), O&M (Operation and Maintenance), OSS (Operational Support System), SON (Self-Organising Networks), positioning node (e.g. E-SMLC (Evolved Serving Mobile Location Centre)), MDT (Minimisation of Drive Tests) etc.

User Equipment:

In some embodiments the non-limiting term user equipment (UE) is used and it refers to any type of wireless device communicating with a radio network node in a cellular or mobile communication system. Examples of UE are target device, device to device UE, machine type UE or UE capable of machine to machine communication, PDA (Personal Digital Assistant), tablet computer (such as an Apple iPad), mobile terminals, smart phone, laptop embedded equipped (LEE), laptop mounted equipment (LME), USB (Universal Serial Bus) dongles etc.

Homogeneous Networks:

A homogeneous network is a network of base stations (e.g. Node Bs) in a planned layout and a collection of user terminals in which all base stations have similar transmit power levels, antenna patterns, receiver noise floors, and similar backhaul connectivity to the data network. Moreover, all base stations offer unrestricted access to user terminals in the network, and are able to serve roughly the same number of user terminals. Current wireless system comes under this category for example includes GSM (Global System for Mobile Communication), WCDMA, HSDPA, LTE (Long Term Evolution), Wimax, etc.

Heterogeneous Networks:

In heterogeneous networks, in addition to the planned or regular placement of larger High Power Nodes (HPN) 1, several low power nodes (LPN) (e.g. pico/femto/relay base stations) 1′ are deployed as shown in FIG. 1. In one embodiment, the LPNs 1′ are placed within a coverage area 4 (also known as cell) of an associated HPN 1. It is to be noted that both the LPNs 1′ and the HPN 1 are radio network nodes, the structure of which is described in more detail below.

Note that the power transmitted by these LPNs 1′ is relatively small compared to that of a High Power Node (such as a macro base stations) 1, e.g. up to 2 W as compared to that of 40 W for the HPN 1. These Low Power Nodes (LPN) 1′ can be deployed to eliminate coverage holes which can be present in the homogeneous networks (using HPNs only). This thereby improves the capacity in hot-spots 4′ which are coverage areas of the respective LPNs 1′. Due to their lower transmit power and smaller physical size, the LPNs 1′ can offer flexible site acquisitions.

The low power nodes 1′ in heterogeneous networks can have
a. Different cell identifier as that of an associated HPN 1 (different cells)
b. Same cell identifier as that of an associated HPN 1 (soft, shared, or combined cell)

FIG. 2 shows the heterogeneous network where low power nodes create different cells, i.e. the LPNs 1′ have different cell identifiers compared to the HPN 1. Simulations shows that using low power nodes 1′ in a macro cell (of a HPN 1) offers load balancing, which improves system throughout as well as cell edge user throughput.

One disadvantage of this topology is that each LPN 1′ creates a different cell (Cell B, C), whereby a UE 10 needs to do soft handover when moving from one hotspot 4′ to the macro cell 4 or to another hotspot 4′. Hence, higher layer signaling is needed to perform handover.

FIG. 3 shows the heterogeneous network where low power nodes 1′ are part of the macro cell. The HPN 1 (e.g. macro node) controls and manages the LPNs 1′ connected within the combined cell 4. For example, the serving HPN 1 may configure the LPNs 1′ with radio parameters for transmitting and receiving signals from a UE 10. This is sometimes interchangeably called as a soft cell or shared cell or even common cell, CoMP (Coordinated Multi-Point (transmission and/or reception)), distributed antenna system (DAS), radio remote head (RRH) or radio remote unit (RRU) deployment scenario etc. This set up avoids the frequent soft handovers, hence higher layer signaling.

Transmission Modes in Combined Cell Deployment:

Based on the data transmission from different nodes transmission modes in combined cell deployment can be divided into two variants, single frequency network and node selection with spatial re-use:

Single Frequency Network:

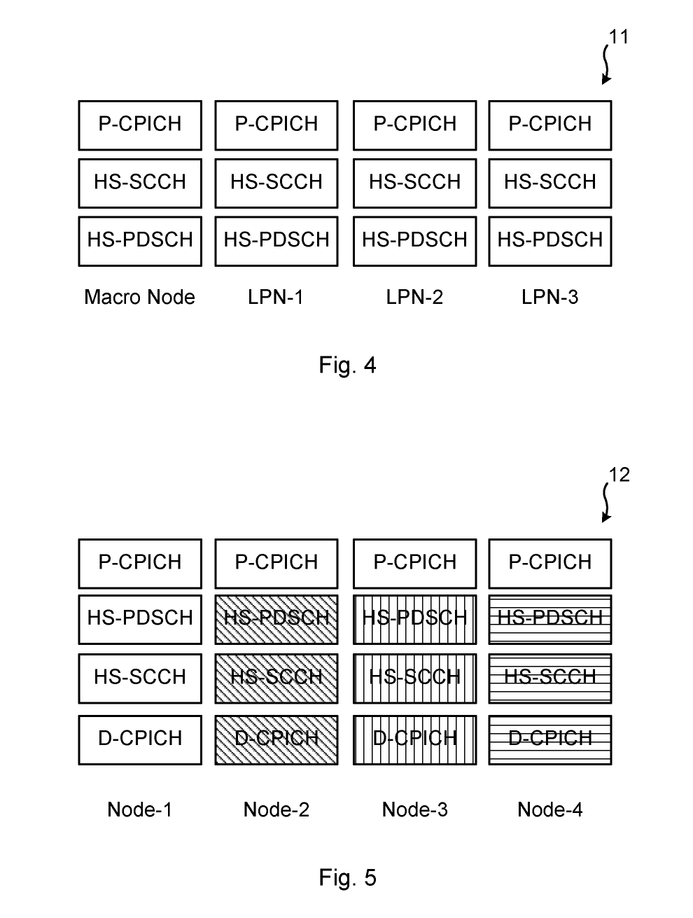

In this mode all nodes 1, 1′ transmit the same pilot channel, and data and control information is transmitted from all the nodes 1, 1′. Note that in this case, only one UE can be served from all the nodes at any time. Hence this mode is useful for coverage improvement. Furthermore, this mode works for all legacy UEs. FIG. 4 shows the pictorial view of the single frequency network mode. Here, the macro node and low power nodes (LPN-1 to LPN-3) all have the same P-CPICH (Primary Common Pilot Channel), HS-SCCH (High Speed Shared Control Channel), and HS-PDSCH (High Speed Physical data shared channel).

Node Selection with Spatial Re-Use:

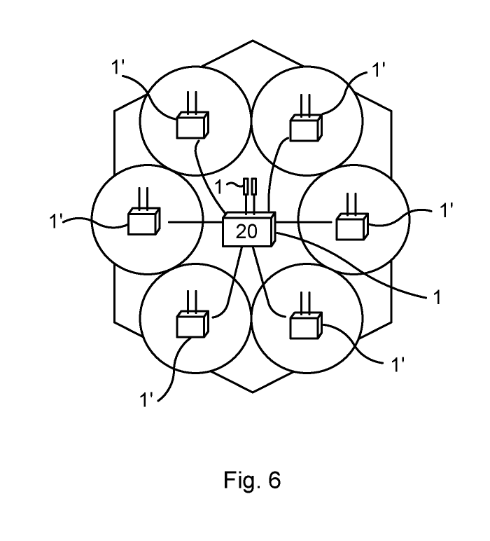

In this spatial reuse mode, even though all the nodes transmit the same pilot channel, data and control information transmitted from each node is different from that of every other, or at least one, node, i.e. one or more nodes will be serving a specific UE, while at the same time different data and control channel information will be sent to a different UE. Hence the spatial resources can be reused. This means the CDMA channelization codes are reused for transmissions to different UEs from one or more transmitting nodes. For example, UE1 and UE2 may be served by node 1 and node 2 respectively using the same channelization codes 1-5 (also known as Orthogonal Variable Spreading Factor (OVSF) codes). The transmissions to different UEs are scrambled with the same scrambling code since the same pilot channel (e.g. P-CPICH) is used in all transmitting nodes. However, since information is also scrambled with the UE's temporary identity (e.g. H-RNTI (HS-DSCH Radio Network Transaction Identifier) the UE can decode the transmission intended for it. However if a signal from a non-serving node is strong then the UE reception quality is degraded as described in a later section. This mode provides load balancing gains hence the capacity of the combined cell can be increased significantly. FIG. 5 shows a pictorial view of the node selection with spatial re-use. Here, all nodes, node 1-node 4, share the P-CPICH, but each node has its own HS-PDSCH, HS-SCCH, and D-CPICH (Demodulation Common Pilot Channel).

FIG. 6 shows one configuration of a combined cell deployment where a central controller 20 is a network node connected to or forming part of the HPN 1 in the combined cell taking responsibility for collecting operational statistics information of network environment measurements from the LPNs 1′. The central controller 20 is central to the combined cell, but not necessarily for the whole mobile communication network of which the central controller 20 is one part. The decision of which nodes 1′, 1 are to transmit to a specific UE is made by the central controller 20 based on the information provided by the UE or on its own. The cooperation among various nodes is instructed by the controller of the HPN 1 and is implemented in a centralized way.

Issues

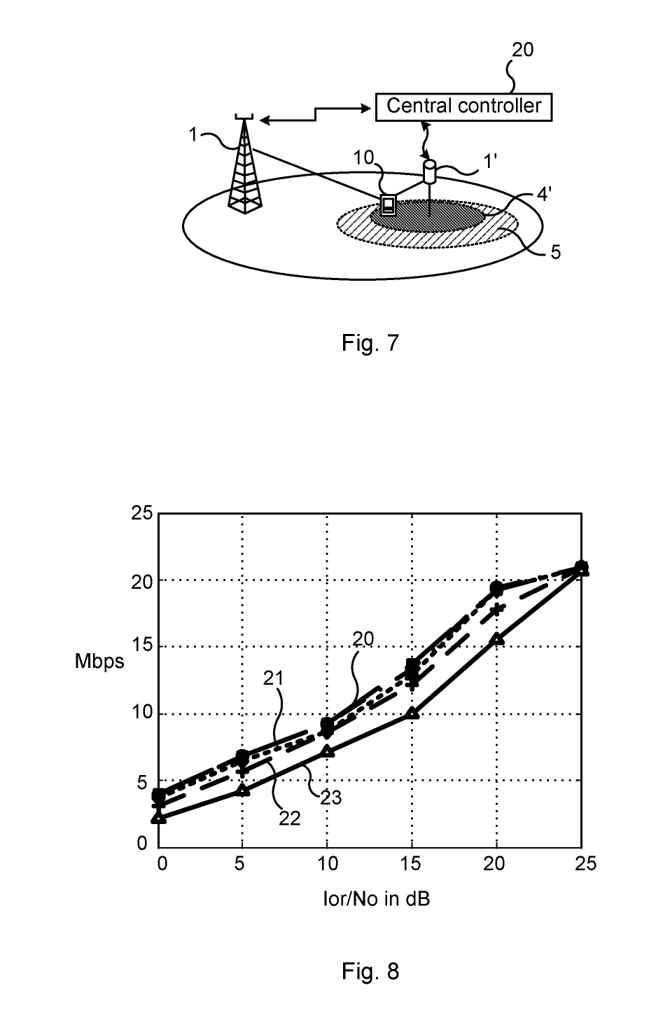

FIG. 7 shows a UE 10 being within the coverage area of a LPN 1′ and also within the coverage area of a HPN 1. A central controller 20 controls the operation of at least some aspects of both the HPN 1 and the LPN 1′. In FIG. 7, range expansion 5 of the LPN 1′ can also be seen. Range expansion 5 is when the coverage area 4′ of a radio network node is expanded. This can occur even if Channel Quality Indications (CQI) indicate that the HPN 1 should be serving the UE 10, e.g. due to load for the HPN 1.

FIG. 8 shows the performance loss when the interference power is low. A solid line 23 represents a scenario where Ioc (Interference from Other Cells) is 0 dB. A medium dashed line 22 represents a scenario where Ioc is −5 dB. A short dashed line 21 represents a scenario where Ioc is −10 dB. A long dashed line 20 represents a scenario where Ioc is −15 dB. It can be seen that the performance loss is almost negligible if the interference power is below −5 dB.

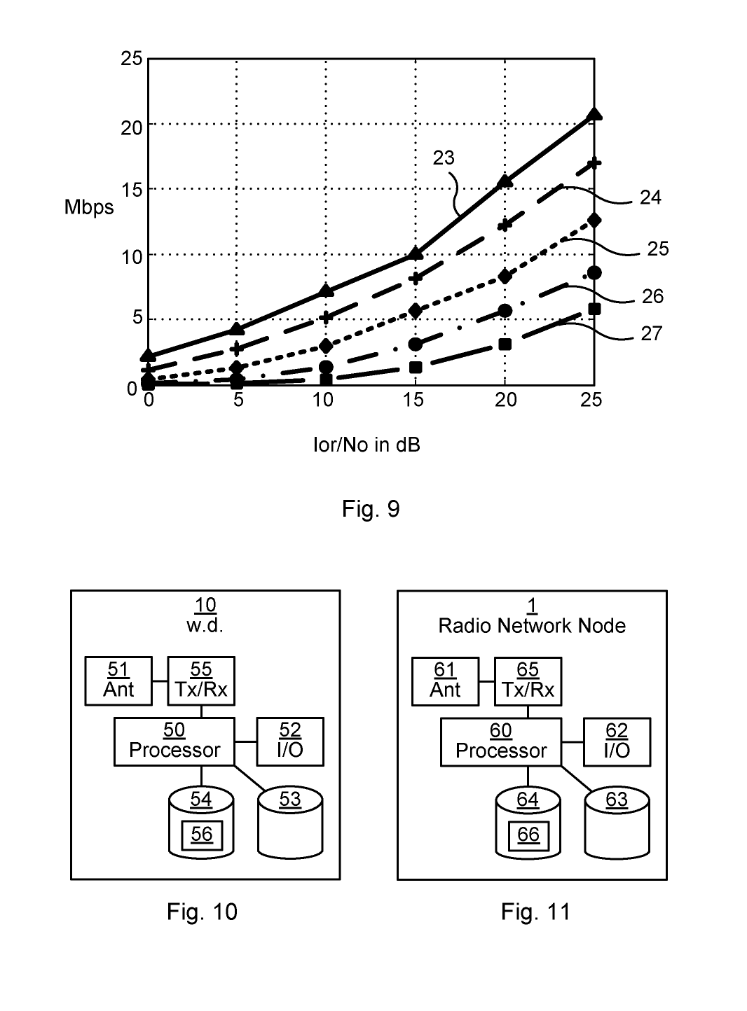

FIG. 9 shows the performance loss when the interference power is high. A solid line 23 represents a scenario where Ioc (Interference from Other Cells) is 0 dB. A medium dashed line 24 represents a scenario where Ioc is 5 dB. A short dashed line 25 represents a scenario where Ioc is 10 dB. A dash dotted line 26 represents a scenario where Ioc is 15 dB. A long dashed line 27 represents a scenario where Ioc is 20 dB. In this case, we see a huge degradation in link throughput with increased interference.

In embodiments presented herein, a mechanism is described (e.g. at the network node being the central controller 20, also known as central scheduler) to avoid the performance loss in combined cell deployments when it is operating in the spatial reuse mode.

One concept of embodiments presented herein is that when at least two UEs operate in a combined cell (or shared cell) then the network node (e.g. HPN) managing the combined cell uses one or more criteria to trigger transmissions to different UEs from their respective serving nodes within the combined cell using orthogonal CDMA channelization codes (e.g. CDMA OVSF codes).

There are multiple embodiments of this:

In one embodiment the HPN (or associated network node e.g. being the central controller), based on one or more criteria, configures the LPNs within the combined cell to serve a second set of UEs under its control using second set of channelization codes, which are orthogonal to the first set of the channelization codes, wherein the first set is used by the HPN for serving a first set of UEs.

In one embodiment, based on one or more criteria, the HPN (or associated network node e.g. being the central controller) configures each LPN within the combined cell with a set of channelization codes, wherein each configured set is orthogonal between all LPNs and also between each LPN and the HPN.

In one embodiment, based on one or more criteria, the HPN (or associated network node) configures:
one set of channelization codes as orthogonal codes between HPN and LPNs or between LPNs using the principles disclosed in the first embodiment or in the second embodiment respectively, and
another set of channelization codes (i.e. remaining codes) for reusing them in all the nodes within the combined cell (HPN and LPNs).

The criteria to decide whether to spatially reuse all the channelization codes in the combined cell or use the channelization codes according to one of the modes for downlink transmissions may comprise any one or more of the following: characteristics of signal or service or traffic characteristics of transmissions to the UE, load, transmission power level, UE and radio network node capability of handling the code assignment mode, mode used in neighboring combined cell, etc. The method further uses these criteria when selecting the most appropriate mode.

The method in the network node may further comprise informing the UE operating in the combined cell or other neighboring network nodes about the mode configured for use in the combined cell and may further inform them with the additional information (e.g. channelization codes) associated with the configured mode, which information is used by the UE or other nodes for adapting or performing one or more radio procedures or operation or task.

More Details

More details of embodiments will now be described with reference to the following:
Method in a network node of selecting orthogonal code assignment mode based on criteria
Method in a network node of configuring the selected orthogonal code assignment mode in other network nodes
Method in a network node of informing the UE and other nodes of selected orthogonal code assignment mode
Method in a radio node (UE or radio network node) of signaling its capability of handling different orthogonal code assignment modes

The above methods may be combined where appropriate in a combined method.

The above embodiments are described below.

In embodiments presented herein, we propose a mechanism (e.g. at the network node e.g. the central controller 20) to avoid the performance loss in combined cell deployments when it is operating in the spatial reuse mode.

Method in a Network Node of Selecting Orthogonal Code Assignment Mode Based on Criteria

Orthogonal Code Assignment Modes

Several orthogonal code assignment modes or schemes are disclosed. The orthogonal code assignment mode is used by the network node for assigning all or partial set of CDMA channelization codes (out of the total available codes) in an orthogonal manner between different nodes within a combined cell. The HPN (or associated network node) can control or manage the LPNs within the combined cell and assigns the selected set of orthogonal codes for DL transmission to the UE in different LPNs.

For example, the HPN may assign channelization codes 1-5 and 6-10 to LPN1 and LPN2 for downlink transmission to their respective UE1 and UE2 even when the same pilot channel is used in all nodes in the combined cell. Thanks to the orthogonal codes, the interference at the UE2 caused by transmission to UE1 can be avoided or minimized.

The different possible modes may be pre-defined in the standard.

Three specific examples of different orthogonal code assignment modes are provided below.
Orthogonal Codes between HPN and LPNs within Combined Cell:

In the first exemplary mode, the available set of the orthogonal channelization codes (e.g. CDMA OVSF codes) are divided onto two groups. The codes in first groups are orthogonal to the codes in the second group. The size of the two groups (i.e. number of codes) may be the same or can also be different. For example, the first group may contain 128 codes whereas the second group may also contain 120 codes, where each code has spreading factor (SF) of 256. In another example, the first group may contain 8 codes whereas the second group may also contain 8 codes, where each code has SF of 16.In yet another example, the first group may contain 4 codes whereas the second group may also contain 12 codes, where each code has SF of 16. The codes in the first group are used by the HPN for serving UEs under its control within the combined cell. The codes in the second group are used by the LPNs for serving UEs under their control within the combined cell; the LPNs can reuse the same codes for serving their UEs e.g. LPN1 and LPN2 can use the same codes 1-5 for serving UE1 and UE2 respectively.
Orthogonal Codes between All Nodes within Combined Cell:

In the second exemplary mode, the available set of the orthogonal channelization codes (e.g. CDMA OVSF codes) are divided onto N groups, where N is the number of nodes (including LPNs and the serving or controlling HPN) within the combined cell. The codes in each group are orthogonal to the codes in all other groups. This means each node (LPN or HPN) transmits signals to its own UE using the channelization codes which are orthogonal to the codes used for transmitting all other UEs within the combined cell. The size of the N groups (i.e. number of codes) may be the same or can also be different. The size may depend upon the load at each LPN.
Combination of Spatially Reused and Orthogonal Codes between Nodes within Combined Cell:

In the third exemplary mode, the available set of the orthogonal channelization codes (e.g. CDMA OVSF codes) are divided onto two primary groups: first and second primary group of codes. The codes between the two primary groups are orthogonal. The codes in the first primary group can be spatially reused in all N nodes within the combined cell. The codes in the second primary group are further divided according to the first mode or according to the second mode or combination thereof. For example, the codes in the second primary group can be divided into first subset of codes for use at the HPN for serving its UEs and the remaining ones for use at the LPNs for serving their UEs; each one of the codes in the first subset are orthogonal to each one of the codes in the second subset. The size of the primary groups (i.e. number of codes) may be the same or can also be different. Similarly, the size of subsets of codes may also be the same or different.

Criteria for Selecting the Mode

A suitable network node or radio network node may firstly decide to use one of the modes for code assignment to nodes in the combined cell in response to a triggering condition, which in turn occurs based on one or more criteria.

The suitable network node or radio network node may also select the mode and also select the size of each group (in terms of number of codes, their SF etc.) based on one or more criteria. Examples of network node that may perform this task are BS or Node B serving all LPNs within the combined cell. In another example the RNC controlling the Node B or BS may also select the mode. The network node uses one or more criteria to select the mode for assigning channelization codes to nodes within the combined cell. The non-limiting examples of criteria for triggering and also for selecting the mode are:
User traffic or service characteristics
Load
Signal quality
UE capability of handling different modes
UE receiver capability
Combination of criteria

The above criteria are elaborated below:
User Traffic or Service Characteristics:

In case there are certain number or more of users (e.g. more than 5 users) which intend to use or are using similar service or traffic characteristics (e.g. VoIP) then the network node may decide to use one of the modes that would ensure the use of orthogonal codes for serving UEs with the same traffic characteristics. For example, the network node may select second mode (all nodes use orthogonal codes) in case all nodes serves the users with similar traffic behavior. The use of orthogonal codes will ensure that, on average, the interference is reduced.
Load:

The load can be estimated based on transmitted power of the node, number of users in a combined cell, number of physical channels e.g. CDMA codes etc.) used in a combined cell, number of activated users in a combined cell etc. Under high load, the signal received at certain UEs is more severely and adversely affected by the interference caused by transmissions from other nodes on the same codes as used by that UE. This degrades the UE reception quality. Therefore, under high load, the network node may use one of the modes e.g. it may use first mode if the load is higher mainly in HPN, second mode in case the load is higher in all or most of the nodes.
Signal Quality:

The network may use the first or second mode for code assignment to nodes within the combined cell provided that UE received signal quality is worse than a threshold. This may occur due to strong interference from the interfering nodes. The signal quality of a UE can be expressed in terms of a suitable radio measurement. The radio measurements are generally performed by the UE and reported to the network. It can also be determined by the serving node of the UE based on the UE feedback sent to the network e.g. HARQ (Hybrid Automatic Repeat Request) ACK (Acknowledgement)/NACK (Negative ACK) for DL (Downlink) signal reception. Examples of radio measurements are CSI measurements (e.g. CQI (Channel Quality Indication), PCI (Precoding Control Index), rank indicator etc.), user signal quality in general, data rate, service type (e.g. whether requires higher data rate or not), geometry (e.g. ratio of received power from own cell to that from neighboring cells), SINR (Signal to Interference and Noise Ratio), SNR (Signal to Noise Ratio), BLER (Block Error Rate), BER (Bit Error Rate), FER (Frame Error Rate), ACK/NACK for DL signal reception, CPICH measurements (CPICH RSCP (Received Signal Code Power), CPICH Ec/No) etc.
UE Capability of Handling Signal Reception based on Different Modes:

The network node may decide whether to configure one of the modes for code assignment by taking into account the UE capability associated with the handling of different orthogonal code assignment modes (described below). For example, the network node may use one of the modes for orthogonal code assignment in case at least certain number of users operating in the combined cell cannot receive signals with sufficient quality if the codes are spatially reused. In this way by using orthogonal codes in nodes within the combined cell, the signal quality at the UE receiver can be enhanced.
UE Receiver Capability:

The network node may decide whether to configure one of the modes for code assignment by taking into account the UE receiver capability of receiving signals from the radio network node. For example, if several users in the combined cell don't have an enhanced receiver to receive signals in the presence of interference caused by transmissions from other nodes, then the network node may use one of the orthogonal code assignment modes. The network node may determine the UE enhance receiver capability based on a suitable mechanism e.g. based on explicit indication received from the UE.
Orthogonal Code Assignment Strategy Used in Neighboring Combined Cells(s):

The network node assigning the mode to the first combined cell may also take into account whether one or more neighboring combined cell of the first combined cell also use an orthogonal code assignment strategy or not. The network node may further take into account the types of mode used in one or more neighboring combined cells. The network node acquires this information by exchanging information between network nodes as described below. For example, if a neighboring combined cell uses the second mode (all nodes use orthogonal codes) then the network node may expect less interference in the first combined cell from the neighboring combined cell. Therefore, the network node may use a less aggressive mode such as the third mode i.e. only subset of channelization codes assigned in different nodes within the first combined cell is orthogonal.

Method in a Network Node of Configuring the Selected Orthogonal Code Assignment Mode in Other Network Nodes

The network node (e.g. serving Node B, serving BS, serving RNC (Radio Network Controller) etc. managing the combined cell) upon selecting an appropriate mode for orthogonal code assignment for DL transmissions by nodes in a combined cell, configures the nodes (e.g. LPN within the combined cell) with the selected mode. The method in the network node further comprises assigning the orthogonal set of codes within the selected mode to the nodes in the combined cell. The network node may even further inform the nodes about the spatially reused codes (i.e. codes which are reused in all nodes), for example if exemplary third mode is used.

In one example the network node may provide to a radio network node only the list of codes which can be used by that node for DL transmission to its UEs, e.g. informs LPN1 that it can use codes 1-10, LPN2 can use codes 11-20 etc.

In another example the network node may provide complete list of available codes to all nodes in the combined cell, wherein each code or set of codes is tagged with the node ID (e.g. LPN1 ID, HPN ID etc.) of the node which is allowed to use that code. This enables each node to know also the codes assigned to other nodes.

In the above two examples, the network node may further explicitly inform the radio network nodes in the combined cell:
whether the channelization codes configured for use in the combined cell are based on spatially reuse mechanism or based on orthogonal code assignment mode and/or
about the mode (e.g. mode ID) used in the combined cell in case orthogonal code assignment is used. The mode can be pre-defined and therefore the receiving node based on the mode ID can determine the scheme configured for orthogonal code assignment.

If the network node is an RNC then it may provide the above information to the Node B over Iub interface. The receiving Node B may eventually configure LPN with the mode and codes e.g. configure LPN such as RRH over an interface between Node B and RRH. The Node B may receive the information from the RNC proactively or in response to sending request to the RNC.

The receiving node in the combined cell uses the received information to transmit the DL signals to its UE e.g. uses the assigned codes for transmitting HS-DSCH (High Speed Downlink Shared Channel), HS-SCCH (High Speed Shared Control Channel), AGCH (Access Grant Channel), etc.

Method in a Network Node of Informing the UE and Other Nodes of Selected Orthogonal Code Assignment Mode
Signaling to UE:

The network node which configures the orthogonal code assignment mode in a combined cell or the network node that has this information and can also communicate with the UE, signals information related to the configured mode to the UE operating in the combined cell. The information may contain an indicator or ID of the pre-defined orthogonal code assignment mode(s) e.g. first mode where codes used by HPN and LPNs in the combined cell are orthogonal. The network node may provide limited information. For example, it may also inform the UE whether all codes used in the combined cell where UE is operating are spatially reused or are used according to one of the orthogonal code assignment modes.

For example, the RNC may signal the information to the UE via an RRC (Radio Resource Control) message. Alternatively, the Node B may signal the information to the UE via layer 1 or layer 2 messages e.g. HS-SCCH orders, MAC (Medium Access Control) command etc.

The UE, upon receiving the information, may use it for one or more radio operations. Examples of radio operations are adjustment of receiver's parameters, selection of the type of receiver for receiving signals from serving node, etc. For example, if the first mode is used in the combined cell then the UE may use less robust receiver for receiving signals. A more robust receiver compared to baseline or less robust receiver can more effectively reduce or minimize interference caused by the spatially reused codes. However more robust receiver consumes more power and also involves more complexity and processing. On the other hand, if the UE is provided an indication that the combined cell where it is operating is configured with the spatially reused codes (i.e. all codes are reused in all nodes), then the UE may select more robust receiver to receive signals from its serving node(s).
Signaling to Other Network Node:

The network node may further signal the information to other network node managing or configuring the neighboring combined cells. For example, the Node B may inform this to the RNC via an Iub interface. The RNC may signal the information to other one or more other RNCs via an Iur interface.

The network node upon receiving the information, may use this when configuring the codes in other combined cells (as described above).

Method in a Radio Network Node of Signaling its Capability of Handling Different Orthogonal Code Assignment Modes

The node herein can be UE or it can also be radio network node (e.g. BS, Node B, RRH etc.).

Capability Information

The radio node may inform the network node (e.g. UE informs to serving node, core network node etc. or Node B informs to RNC, code network node, etc.), whether it is capable of handling the use of spatially reused channelization codes or orthogonally assigned channelization codes, or both. The capability information may further comprise additional information:

For example, the UE capability information may indicate whether the UE is capable of:
Receiving signals from serving cell when channelization codes used in the combined cell where the UE operates are spatially reused in nodes within the combined cell, or
Receiving signals from serving cell only when channelization codes used in the combined cell where the UE operates are orthogonal used in nodes within the combined cell and/or
Receiving signals from serving cell only when channelization codes used in the combined cell where the UE operates are orthogonal used in nodes within the combined cell according to certain mode (e.g. first mode or all modes)

For example, the radio network node capability information may indicate whether the radio network node is capable of:
Configuring or operating nodes within the combined cell using one or more modes related to orthogonal assignment of codes, and/or
Configuring or operating certain number of nodes (e.g. LPNs) within the combined cell using one or more modes related to orthogonal assignment of codes

Mechanism of Signaling Capability Information

The UE can signal the above mentioned capability information to the network node using higher layer protocol signaling e.g. RRC protocol.

The UE may send the above mentioned capability information to the network node in any of the following manner:
Proactive reporting without receiving any explicit request from the network node (e.g. serving or any target network node)
Reporting upon receiving any explicit request from the network node (e.g. serving or any target network node)
The explicit request can be sent to the UE by the network anytime, at any specific occasion, in response to a trigger or an event when certain condition is met. For example, the request for the capability reporting can be sent to the UE during initial setup or after a cell change (e.g. handover, RRC connection re-establishment, RRC connection release with redirection, PCell (Primary Cell) or primary serving cell change in CA (Carrier Aggregation), primary component carrier (PCC) or primary carrier change in CA etc.). In another example the UE may send the capability to the network node when certain condition is met e.g. signal quality is below a certain threshold or when operating in a certain frequency band.

The radio network node may signal the above information to the other network node proactively or in response to a request message received from the requesting node (e.g. during audit procedure used between the RNC and Node B to inquire Node B capability). The radio network node may signal the capability to the network node during initial setup or when its configuration is changed.

Actions in Network Mode

The network node (e.g. serving RNC, BS, Node B, eNode B, BS etc.) uses at least the received UE capability information in order to decide the type of mode to use for code assignment in a combined cell. The network node uses the received capability of plurality of UEs to decide and select the code assignment mode (as described above).

But, additionally, the network node may also forward the received UE capability information to other network nodes e.g. to neighboring radio network node, SON, O&M, OSS etc. This will avoid the need for the UE to again reports its capability to a new serving radio node after the cell change e.g. after handover. In this way, signaling overheads can be reduced and the target radio node can quickly select the appropriate receiver type.

The network node may also use the above radio network node capability to decide which mode to configure or recommend for use in the combined cell which is served by the radio network node. Accordingly the network node configures the radio network nodes with the selected mode and further configures it with one or more parameters (e.g. set of codes) related to the selected mode, wherein the selected mode is supported by the radio network node as indicated in the capability information.

FIG. 10 is a schematic diagram illustrating some components any one of the UEs described above, here illustrated as a single UE 10.

A processor 50 is provided using any combination of one or more of a suitable central processing unit (CPU), multiprocessor, microcontroller, digital signal processor (DSP), application specific integrated circuit etc., capable of executing software instructions 56 stored in a computer program product 54, e.g. in the form of a memory. The processor 50 may be configured to execute methods and/or procedures described above, by executing instructions 56 stored in the computer program product 54.

The computer program product 54 may be a memory or any combination of read and write memory (RAM) and read only memory (ROM). The memory also comprises persistent storage, which, for example, may be any single one or combination of magnetic memory, optical memory, solid state memory or even remotely mounted memory.

The UE 10 further comprises a data memory 53, which comprises persistent and/or volatile memory for storing data, e.g. used by the instructions 56 when executed by the processor 50.

The UE 10 further comprises an I/O interface 52 for communicating with the core network and optionally with other network nodes.

The UE 10 also comprises one or more transceivers 55, comprising analogue and digital components, and a suitable number of antennas 51 for radio communication with a suitable network node 1. The processor 50 controls the general operation of the UE 10, e.g. by sending control signals to the transceiver 55 and receiving reports from the transceiver 55 of its operation.

FIG. 11 is a schematic diagram illustrating some components any one of the radio network nodes described above, here illustrated as a single radio network node 1.

A processor 60 is provided using any combination of one or more of a suitable central processing unit (CPU), multiprocessor, microcontroller, digital signal processor (DSP), application specific integrated circuit etc., capable of executing software instructions 66 stored in a computer program product 64, e.g. in the form of a memory. The processor 60 may be configured to execute methods and/or procedures described above, by executing instructions 66 stored in the computer program product 64.

The computer program product 64 may be a memory or any combination of read and write memory (RAM) and read only memory (ROM). The memory also comprises persistent storage, which, for example, may be any single one or combination of magnetic memory, optical memory, solid state memory or even remotely mounted memory.

The radio network node 1 further comprises a data memory 63, which comprises persistent and/or volatile memory for storing data, e.g. used by the instructions 66 when executed by the processor 60.

The radio network node 1 further comprises an I/O interface 62 for communicating with the core network and optionally with other network nodes.

The radio network node 1 also comprises one or more transceivers 65, comprising analogue and digital components, and a suitable number of antennas 61 for radio communication with mobile devices within one or more radio cells. The processor 60 controls the general operation of the radio network node 1, e.g. by sending control signals to the transceiver 65 and receiving reports from the transceiver 65 of its operation.

Other network nodes, which are not radio network nodes, have the corresponding components to the radio network node, except the transceiver 65 and the antenna 61 are not necessary.

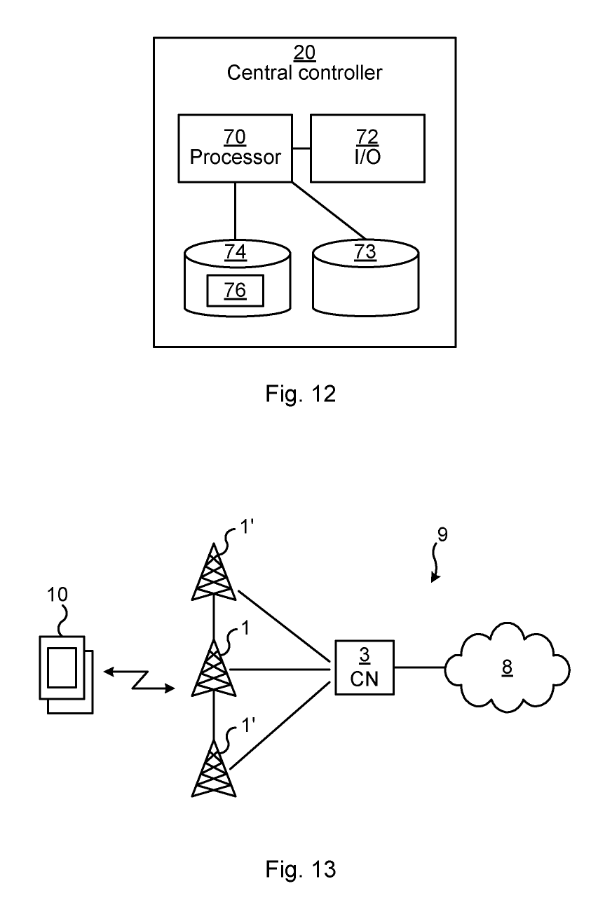

FIG. 12 is a schematic diagram illustrating some components a network node being the central controller 20 described above.

A processor 70 is provided using any combination of one or more of a suitable central processing unit (CPU), multiprocessor, microcontroller, digital signal processor (DSP), application specific integrated circuit etc., capable of executing software instructions 76 stored in a computer program product 74, e.g. in the form of a memory. The processor 70 may be configured to execute methods and/or procedures described above, by executing instructions 76 stored in the computer program product 74.

The computer program product 74 may be a memory or any combination of read and write memory (RAM) and read only memory (ROM). The memory also comprises persistent storage, which, for example, may be any single one or combination of magnetic memory, optical memory, solid state memory or even remotely mounted memory.

The central controller 20 further comprises a data memory 73, which comprises persistent and/or volatile memory for storing data, e.g. used by the instructions 76 when executed by the processor 70.

The central controller 20 further comprises an I/O interface 72 for communicating with the core network and optionally with other network nodes.

FIG. 13 is a schematic diagram illustrating some of the network nodes of an environment where embodiments presented herein can be applied. There are here a radio network node 1 which is a HPN and two radio network nodes 1′ which are LPNs. The mobile communication network 9 may e.g. comply with any one or a combination of W-CDMA (Wideband Code Division Multiplex), LTE (Long Term Evolution), CDMA2000 (Code Division Multiple Access 2000), or any other current or future mobile network, as long as the principles described hereinafter are applicable.

The mobile communication network 9 also comprises a core network 3 for central network functions and connectivity to other networks 8, such as other voice and/or data networks.

The radio network nodes 1, 1′ provide radio connectivity to a plurality of UEs 10. Uplink and downlink communication between each UE 10 and the network node 1 occurs over a wireless radio interface. The quality of the wireless radio interface to each UE 10 varies over time and also depends on the position of the UE 10, due to effects such as fading, multipath propagation, interference, etc.

Optionally, there are one or more Radio Network Controllers (RNC) (not shown) provided between the radio network nodes 1, 1′ and the core network 3, controlling the operation of the radio network nodes 1, 1′.

There are several effects of the embodiments presented here.

Firstly, since there is no interference in the range expansion, significant increase in system throughput, hence the UE throughput can be obtained.

Secondly, coverage and spatial re-use gains are maintained.

Thirdly, the UE operating in a combined cell with baseline receiver or with less robust receiver can also operate, thanks to interference reduction.

Fourthly, the UE operating in a combined cell can use less robust receiver or adjust its receiver's parameters to reduce power consumption and also reduce processing.

It is to be noted that whenever the term ‘set’ is used herein it is a collection or zero, one or more members.

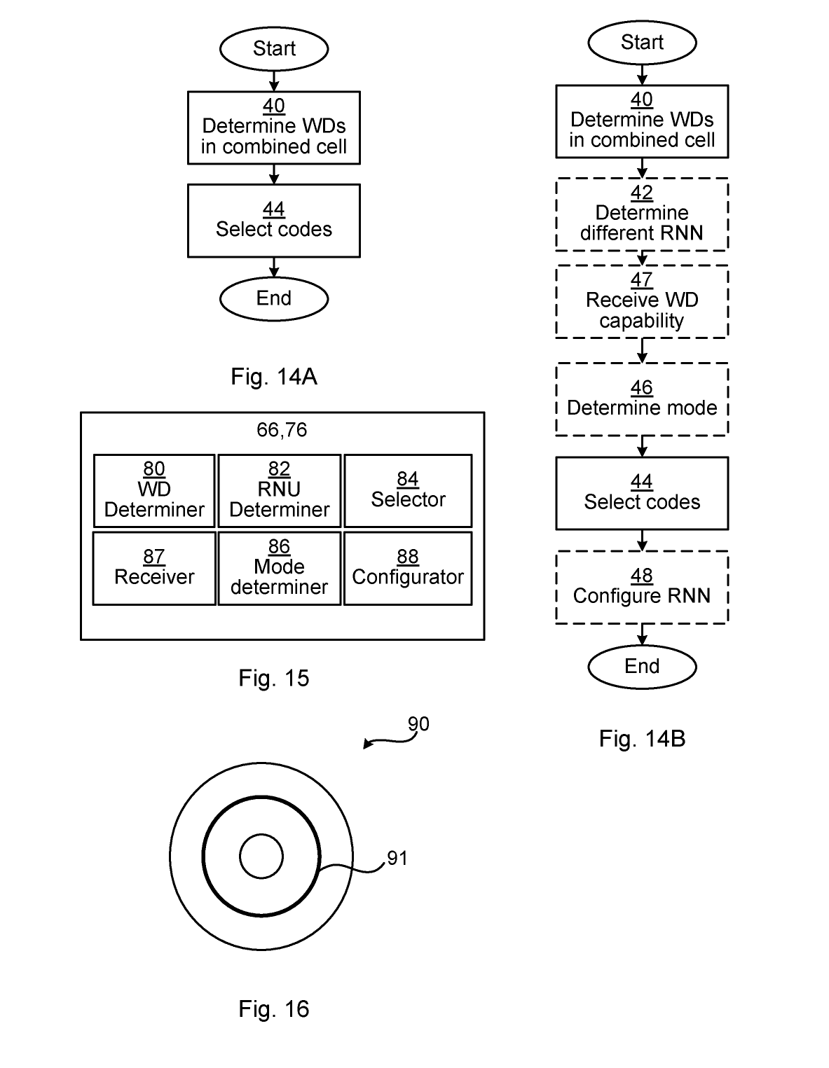

FIGS. 14A-B are flow charts illustrating embodiments of methods performed in the network node of FIGS. 1-3. In other words, the network node is part of a combined cell of a mobile communication network, wherein the combined cell comprises a plurality of radio network nodes which all use the same cell identifier. The network node can e.g. be a high power node of the combined cell or a central controller connected to the high power node. As explained above, the high power node can be a macro node. First the method of FIG. 14A will be described.

In a determine WDs in combined cell step 40, the network node determines that at least two wireless devices operate in the combined cell.

In a select codes step 44, the network node selects orthogonal CDMA channelization codes for respective radio network nodes serving the at least two wireless devices, e.g. as described in any of the various ways above. The channelization codes are used in downlink transmissions to the at least two wireless devices, e.g. over a physical downlink shared channel such as HS-PDSCH. Furthermore, the selected orthogonal CDMA channelization codes are orthogonal between different radio network nodes within the combined cell.

In one embodiment, this step comprises selecting a first set of at least one channelization code for downlink transmissions to a first set of wireless devices and selecting a second set of at least one channelization code for downlink transmissions to a second set of wireless devices. The first set of at least one channelization code and the second set of at least one channelization code are orthogonal. For example, the first set of at least one channelization code can be used for one radio network node and the second set of at least channelization code can be used for another radio network node.

In one embodiment, the selecting of orthogonal CDMA channelization codes comprises using a first mode, by selecting the first set of channelization codes for a high power node of the combined cell and the second set of channelization codes for all low power nodes of the combined cell.

In one embodiment, the selecting orthogonal CDMA channelization codes comprises using a second mode, by selecting one (non-overlapping) set of CDMA channelization codes for each radio network node within the combined cell.

In one embodiment, the selecting orthogonal CDMA channelization codes comprises using a third mode, by selecting a set of at least one spatially reused CDMA channelization code for all radio network nodes with in the combined cell for use in downlink transmissions, and at least two sets of orthogonal CDMA channelization codes according for use in the first mode or the second mode.

The codes of each selected set of CDMA channelization codes are orthogonal to each code or any other selected set of CDMA channelization codes.

In one embodiment, the same CDMA channelization codes are reused for low power nodes arranged such that there is only minimal risk of them interfering with each other. For example, in FIG. 2, the low power node for Cell B and the low power node Cell C can have the same set of CDMA channelization codes since their coverage areas do not overlap and thus only minimally or even negligibly interfere with each other.

Now the method of FIG. 14B will be described. This method is similar to the method illustrated in FIG. 14A and only new or modified steps, in relation to the method of FIG. 14A, will described here.

Prior to the select codes step 44, there are here an optional determine different RNN step 42, an optional receive WD capability step 47 and an optional determine mode step 46.

In the optional determine different RNN step 42, the network node determines that at least two of the at least two wireless devices are served by different radio network nodes. This can be one condition to proceed in the method.

In the optional receive WD capability step 47 a capability of the wireless device indicating its capability of handling of spatially reused CDMA channelization codes, orthogonally assigned channelization codes, or both is received.

In the optional determine mode step 46, a mode to use is determined based on any one or more of the following criteria: user traffic or service characteristics, load, signal quality, wireless device capability of handling different modes, user traffic characteristics and wireless device receiver capability.

In an optional configure RNN step 48, the radio network nodes are configured in accordance with the mode used, comprising assigning the selected CDMA channelization codes.

FIG. 15 is a schematic diagram showing functional modules of the software instructions 76 of the network node of FIG. 12 according to one embodiment. The modules are implemented using software instructions such as a computer program executing in the network node. The modules correspond to the steps in the methods illustrated in FIGS. 14A-B.

A WD determiner 80 is arranged to determine that at least two wireless devices operate in the combined cell. This module corresponds to the determine WDs in combined cell step 40 of FIGS. 14A-B.

A RNN determiner 82 is arranged to select orthogonal CDMA channelization codes for respective radio network nodes serving the at least two wireless devices, for use in downlink transmissions to the at least two wireless devices. This module corresponds to the determine different RNN step 42 of FIG. 14B.

A selector 84 is arranged to select orthogonal CDMA channelization codes for respective radio network nodes serving the at least two wireless devices. This module corresponds to the select codes step 44 of FIGS. 14A-B.

A receiver 87 is arranged to receive a capability of the wireless device indicating its capability of handling of spatially reused CDMA channelization codes, orthogonally assigned channelization codes, or both. This module corresponds to the receive WD capability step 47 of FIG. 14B.

A mode determiner 86 is arranged to determine a mode to use based on any one or more of the following criteria: user traffic or service characteristics, load, signal quality, wireless device capability of handling different modes, user traffic characteristics and wireless device receiver capability. This module corresponds to the determine mode step 46 of FIG. 14B.

A configurator 88 is arranged to configure radio network nodes in accordance with the mode used. This module corresponds to the configure RNN step 48 of FIG. 14B.

FIG. 16 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 76 of FIG. 12. While the computer program 91 is here schematically shown as a track on the depicted optical disk, the computer program can be stored in any way which is suitable for the computer program product, such as a removable solid state memory, e.g. a Universal Serial Bus (USB) drive.

### Enumerated Embodiments

In the following a number of non-limiting enumerated embodiments will be presented.

1.A method, performed in a network node of a combined cell of a mobile communication network, wherein the combined cell comprises a plurality of radio network nodes which all use the same cell identifier, the method comprising:
determining that at least two UEs, User Equipments, operate in the combined cell; and
selecting orthogonal CDMA, Code Division Multiple Access, channelization codes for respective radio network nodes serving the at least two UEs, for use in downlink transmissions to the at least two UEs.

2. The method according to embodiment 1, further comprising:
determining that at least two of the at least two UEs are served by different radio network nodes.

3. The method according to any one of the preceding embodiments, wherein the network node is connected to a high power node, e.g. a macro node, of the combined cell.

4. The method according to any one of the preceding embodiments, wherein the selecting orthogonal CDMA channelization codes comprises selecting a first set of at least one channelization code for downlink transmissions to a first set of UEs and selecting a second set of at least one channelization code for downlink transmissions to a second set of UEs.

5. The method according to embodiment 4, wherein the selecting orthogonal CDMA channelization codes comprises using a first mode, by selecting the first set of channelization codes for a high power node of the combined cell and the second set of channelization codes for all low power nodes of the combined cell.

6. The method according to embodiment 4, wherein the selecting orthogonal CDMA channelization codes comprises using a second mode, by selecting the one set of CDMA channelization codes for each radio network node within the combined cell.

7. The method according to embodiment 5 and/or 6, wherein the selecting orthogonal CDMA channelization codes comprises using a third mode, by selecting a set of at least one spatially reused CDMA channelization code for all radio network nodes within the combined cell for use in downlink transmissions, and at least two sets of orthogonal CDMA channelization codes according for use in the first mode or the second mode.

8. The method according to any of embodiments 5-7, further comprising:
determining a mode to use based on any one or more of the following criteria: user traffic or service characteristics, load, signal quality, UE capability of handling different modes, and UE receiver capability.

9. The method according to any one of embodiments 4 to 8, wherein the codes of each selected set of CDMA channelization codes is orthogonal to any each code of any other selected set of CDMA channelization codes.

10. The method according to any one of the embodiments 4 to 9, further comprising:
configuring radio network nodes in accordance with the mode used.

11. The method according to embodiment 10, wherein the configuring comprises assigning CDMA channelization codes to the mode used.

12. The method according to embodiment 10 or 11, wherein the configuring comprises, when the third mode is used, signalling the radio network nodes of what any CDMA channelization codes which are spatially reused CDMA channelization codes

13. The method according to any one of embodiments 10 to 12, further comprising signalling the radio network nodes of what CDMA channelization codes are used by other radio network nodes.

14. The method according to any one of embodiments 5 to 13, further comprising:
signalling the UE in accordance with the mode used.

15. A method performed in a UE, user equipment, comprising:
receiving a signal comprising what mode is used for CDMA channelization code assignments to radio network nodes of a combined cell; and
determining a downlink radio operation based on the signal.

16. The method according to embodiment 15, wherein the determining a downlink radio operation comprises determining selecting parameters for a receiver of the UE.

17. The method according to embodiment 15 or 16, wherein the determining a downlink radio operation comprises using less robust receiver for receiving signals when CDMA channelization codes for different radio network nodes of the combined cell are orthogonal.

18. A method performed in a radio network node being part of a combined cell, wherein the combined cell comprises a plurality of radio network nodes which all use the same cell identifier, the method comprising the steps of:
signalling a capability of the radio network node, regarding its capability of handling of spatially reused CDMA channelization codes, orthogonally assigned channelization codes or both.

19. The method according to embodiment 18, further comprising:
signalling a UE capability of a UE served by the radio network node, wherein the UE capability indicates its capability of handling spatially reused CDMA channelization codes within the combined cell.

20. The method according to embodiment 19, wherein the UE capability comprises the capability of the UE to receive signals from serving radio network node only when CDMA channelization codes used by the serving radio network node are orthogonal to any other CDMA channelization codes used within the combined cell.

21. A network node arranged to be part of a combined cell of a mobile communication network, wherein the combined cell comprises a plurality of radio network nodes which all use the same cell identifier, the network node comprising:
a processor; and
a computer program product storing instructions that, when executed by the processor, causes the network node to:
determine that at least two UEs, User Equipments, operate in the combined cell; and
select orthogonal CDMA, Code Division Multiple Access, channelization codes for respective radio network nodes serving the at least two UEs, for use in downlink transmissions to the at least two UEs.

22. A UE comprising:
a processor; and
a computer program product storing instructions that, when executed by the processor, causes the UE to:
receive a signal comprising what mode is used for CDMA channelization code assignments to radio network nodes of a combined cell; and
determine a downlink radio operation based on the signal.

23. A radio network node arranged to be part of a combined cell, wherein the combined cell comprises a plurality of radio network nodes which all use the same cell identifier comprising:
a processor; and
a computer program product storing instructions that, when executed by the processor, causes the radio network node to:
signal a capability of the radio network node, regarding its capability of handling of spatially reused CDMA channelization codes, orthogonally assigned channelization codes or both.

### ABBREVIATIONS

3GPP 3rd Generation Partnership Project
CoMP Coordinated Multi-Point (transmission and/or reception)
CPICH Common Pilot Channel
DL Downlink
E-SMLC Evolved Serving Mobile Location Centre
GSM Global System for Mobile (Communication)
HARQ Hybrid automatic repeat request
HPN High Power Node
H-RNTI HS-DSCH Radio Network Transaction Identifier
HSDPA High Speed Downlink Packet Access
HSPA High Speed Packet Access
HS-DSCH High Speed Downlink Shared Channel
HS-PDSCH High Speed Physical data shared channel
HS-SCCH High Speed Shared Control Channel
L1 Layer 1
LPN Low Power Node
LTE Long Term Evolution
MAC Medium Access Control
MDT Minimisation of Drive Tests
MIMO Multiple input multiple output
MME Mobility Management Entity
MSC Mobile Switching Centre
O&M Operation and Maintenance
OSS Operational Support System
OVSF Orthogonal Variable Spreading Factor
PCI Precoding control index
P-CPICH Primary Common Pilot Channel
RNC Radio Network Controller
RRC Radio Resource Control
RRH Remote Radio Head
RRU Remote Radio Unit
SON Self-Organising Networks
TTI Transmit Time Interval
Tx Transmitter
UE User Equipment
WCDMA Wideband Code Division Multiple Access

The invention has mainly been described above with reference to a few embodiments. However, as is readily appreciated by a person skilled in the art, other embodiments than the ones disclosed above are equally possible within the scope of the invention, as defined by the appended patent claims.

1. A method, performed in a network node of a combined cell of a mobile communication network, wherein the combined cell comprises a plurality of radio network nodes which all use the same cell identifier, the method comprising:
determining that at least two wireless devices operate in the combined cell; and
selecting orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

2. The method according to claim 1, further comprising:
determining that at least two of the at least two wireless devices are served by different radio network nodes.

3. The method according to claim 1, wherein the network node is a high power node of the combined cell.

4. The method according to claim 3, wherein the high power node is a macro node.

5. The method according to claim 1, wherein the selecting orthogonal CDMA channelization codes comprises selecting a first set of at least one channelization code for downlink transmissions to a first set of wireless devices and selecting a second set of at least one channelization code for downlink transmissions to a second set of wireless devices, wherein the first set of at least one channelization code and the second set of at least one channelization code are orthogonal.

6. The method according to claim 5, wherein the selecting orthogonal CDMA channelization codes comprises using a first mode, by selecting the first set of channelization codes for a high power node of the combined cell and the second set of channelization codes for all low power nodes of the combined cell.

7. The method according to claim 5, wherein the selecting orthogonal CDMA channelization codes comprises using a second mode, by selecting one set of CDMA channelization codes for each radio network node within the combined cell.

8. The method according to claim 6, wherein the selecting orthogonal CDMA channelization codes comprises using a third mode, by selecting a set of at least one spatially reused CDMA channelization code for all radio network nodes within the combined cell for use in downlink transmissions, and at least two sets of orthogonal CDMA channelization codes according for use in the first mode or the second mode.

9. The method according to claim 6, further comprising:
determining a mode to use based on any one or more of the following criteria: user traffic or service characteristics, load, signal quality, wireless device capability of handling different modes, user traffic characteristics and wireless device receiver capability.

10. The method according to claim 5, wherein the codes of each selected set of CDMA channelization codes are orthogonal to each code of any other selected set of CDMA channelization codes.

11. The method according to claim 5, wherein the selecting orthogonal CDMA channelization codes comprises reusing the same COMA channelization codes for low power nodes arranged such that there is only minimal risk of them interfering with each other.

12. The method according to claim 5, further comprising:
configuring radio network nodes in accordance with the mode used.

13. The method according to claim 12, wherein the configuring comprises assigning selected CDMA channelization codes.

14. The method according to claim 1, wherein, in the selecting orthogonal CDMA channelization codes, the downlink transmission relates to transmissions over a physical downlink shared channel.

15. The method according to claim 5, further comprising:
receiving a capability of the wireless device indicating its capability of handling of spatially reused CDMA channelization codes, orthogonally assigned channelization codes, or both.

16. A network node arranged to be part of a combined cell of a mobile communication network, wherein the combined cell comprises a plurality of radio network nodes which all use the same cell identifier, the network node comprising:
a processor; and
a memory storing instructions that, when executed by the processor, causes the network node to:
determine that at least two wireless devices operate in the combined cell; and
select orthogonal COMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

17. The network node according to claim 16, further comprising instructions stored in the memory that, when executed by the processor, causes the network node to determine that at least two of the at least two wireless devices are served by different radio network nodes.

18. The network node according to claim 16, wherein the network node is arranged to be a high power node of the combined cell.

19. The network node according to claim 18, wherein the high power node is a macro node.

20. The network node according to claim 16, wherein the instructions to select orthogonal CDMA channelization codes comprise instructions that, when executed by the processor, causes the network node to select a first set of at least one channelization code for downlink transmissions to a first set of wireless devices and selecting a second set of at least one channelization code for downlink transmissions to a second set of wireless devices, wherein the first set of at least one channelization code and the second set of at least one channelization code are orthogonal.

21. The network node according to claim 20, wherein the instructions to select orthogonal CDMA channelization codes comprise instructions that, when executed by the processor, causes the network node to use a first mode, by selecting the first set of channelization codes for a high power node of the combined cell and the second set of channelization codes for all low power nodes of the combined cell.

22. The network node according to claim 20, wherein the instructions to select orthogonal CDMA channelization codes comprise instructions that, when executed by the processor, causes the network node to use a second mode, by selecting one set of CDMA channelization codes for each radio network node within the combined cell.

23. The network node according to claim 21, wherein the instructions to select orthogonal CDMA channelization codes comprise instructions that, when executed by the processor, causes the network node to use a third mode, by selecting a set of at least one spatially reused CDMA channelization code for all radio network nodes within the combined cell for use in downlink transmissions, and at least two sets of orthogonal CDMA channelization codes according for use in the first mode or the second mode.

24. The network node according to claim 21, further comprising instructions stored in the memory that, when executed by the processor, causes the network node to determine a mode to use based on any one or more of the following criteria: user traffic or service characteristics, load, signal quality, wireless device capability of handling different modes, user traffic characteristics and wireless device receiver capability.

25. The network node according to claim 20, wherein the codes of each selected set of CDMA channelization codes are orthogonal to each code of any other selected set of COMA channelization codes.

26. The network node according to claim 16, wherein the instructions to select orthogonal CDMA channelization code comprise instructions that, when executed by the processor, causes the network node to reuse the same CDMA channelization codes for low power nodes arranged such that there is only minimal risk of them interfering with each other.

27. The network node according to claim 20, further comprising instructions stored in the memory that, when executed by the processor, causes the network node to configure radio network nodes in accordance with the mode used.

28. The network node according to claim 27, wherein the instructions to configure comprise instructions that, when executed by the processor, causes the network node to assign selected CDMA channelization codes.

29. The network node according to claim 16, wherein the downlink transmission relates to transmissions over a physical downlink shared channel.

30. The network node according to claim 16, further comprising instructions stored in the memory that, when executed by the processor, causes the network node to receive a capability of the wireless device indicating its capability of handling of spatially reused CDMA channelization codes, orthogonally assigned channelization codes, or both.

31. A network node comprising:
means for determining that at least two wireless devices operate in a combined cell comprising the network node, wherein the combined cell forms part of a mobile communication network and comprises a plurality of radio network nodes which all use the same cell identifier; and
means for selecting orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

32. A computer program product comprising a non-transitory computer readable storage medium storing program code which, when run on a network node of a combined cell of a mobile communication network, the combined cell comprising a plurality of radio network nodes which all use the same cell identifier, causes the network node to:
determine that at least two wireless devices operate in the combined cell; and
select orthogonal CDMA, Code Division Multiple Access, channelization codes for respective radio network nodes serving the at least two wireless devices, for use in downlink transmissions to the at least two wireless devices, wherein the selected orthogonal CDMA channelization codes are orthogonal between different radio network nodes within the combined cell.

33. (canceled)
